(19) United States
(12) Patent Application Publication
(10) Pub. No.: US 2010/0236435 A1
(43) Pub. Date: Sep. 23, 2010

(54) Drum-changeable device for a printer

(76) Inventors: Hsien-Chang Lin, Hsi Chih City (TW); Chih-Te Yu, Hsi Chih City (TW)

Correspondence Address: Muncy, Geissler, Olds & Lowe, PLLC, 4000 Legato Road, Suite 310, FAIRFAX, VA, 22033, US

(21) Appl. No.: 12/005,423

(22) Filed: Dec. 27, 2007

(51) Int. Cl. B41F 21/00

(52) U.S. Cl. 101/407.1

(57) ABSTRACT

A drum-changeable device for a printer comprises a plurality of drums and a switch device. The drums are disposed under the work surface of a printer. Each drum has a plurality of protrusions covered by the same kind of material and the protrusions of different drum are covered by different kinds of material for moving forward printing articles of different kinds of material. The switch device is connected with the drums for moving a suitable drum toward the work surface of the printer according to the kinds of material of the printing articles.

### BACKGROUND OF THE INVENTION

1. Field of the Invention

The present invention relates to a drum-changeable device for a printer and, more particularly, to a drum-changeable device for a printer for selecting a suitable drum according to different kinds of material of printing articles.

2. Description of the Prior Art

Conventionally, drums are used in printers for moving printing articles forward by rotating the drums. Generally, the drums are covered with etched iron sheets and the printing articles will be moved forward by means of the friction force produced between the etched iron sheets and the contact surface of the articles.

As shown in FIG. 4, a conventional drum 41 is disposed under the work surface 40 of a printer. The drum 41 has a plurality of protrusions 42 and each protrusion 42 protrudes out of the work surface 40 via a corresponding opening 44 on the work surface 40. After a printing article is placed on the work surface 40, paper-pressing wheels corresponding to the protrusions 42 of the drum 41 are moved downward to press the article on the protrusions 42. Besides, the drum 41 is in connection with a motor 50 for rotating the drum 41 and the article is moved forward to continue printing procedure by the rotation of the protrusions 42 of the drum 41.

The drums 41 with protrusions 42 that are covered by etched iron sheets have better effects for moving articles of soft material forward, such as papers. In other words, sufficient friction force can be produced between the etched iron sheets and the articles of soft material to move forward the articles of soft material. However, the drums 41 having protrusions 42 covered by etched iron sheets are not suitable for some other articles of different kinds of material, such as hard material. Therefore, the drums 41 having protrusions 42 covered by etched iron sheets have limited effects when used for moving printing articles of hard material.

Etched granules on the etched iron sheets are unable to be engaged with the contact surface of printing articles of hard material, such as glasses and acrylic boards, and slip phenomenon will occur between the etched iron sheets and the bottom of the printing articles of hard material when these printing articles are moved by a drum 41 having protrusions 42 covered by etched iron sheets. Accordingly, the printing articles of hard material will fail to be moved in the continuing printing procedure. In this case, the drum 41 having protrusions 42 covered by soft material can be used to move forward the printing articles of hard material successfully.

Moreover, due to the limitation of the structure of current printers, it will be difficult to change drums 41 having protrusions 42 covered by different kinds of material when printing articles of different kinds of material are to be printed, such as printing articles of soft material or of hard material. Under this situation, it is inconvenient and not economic because considerable time and labor power have to be wasted.

In order to solve the problems mentioned above to provide a drum-changeable device for a printer to select a suitable drum conveniently according to the kind of material of printing articles, inventor had the motive to study and develop the present invention after hard research.

### SUMMARY OF THE INVENTION

The main object of the present invention is to provide a drum-changeable device for a printer to select a suitable drum conveniently according to different kinds of material of printing articles.

In order to achieve the above object, the present invention provides a drum-changeable device for a printer. The drum-changeable device comprises a plurality of drums and a switch device. The drums are disposed under the work surface of a printer. Each drum has a plurality of protrusions covered by the same kind of material and the protrusions of different drum are covered by different kind of material for moving forward printing articles of different kinds of material. The switch device is connected with the drums for moving a suitable drum toward the work surface of the printer according to the kind of material of printing articles.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is an exploded perspective view showing a drum-changeable device for a printer of the present invention.

FIG. 2 is a perspective view showing the drum-changeable device for a printer of the present invention.

FIG. 3 shows a using state diagram of the drum-changeable device for a printer of the present invention.

FIG. 4 is a schematic view showing a printer with a conventional drum.

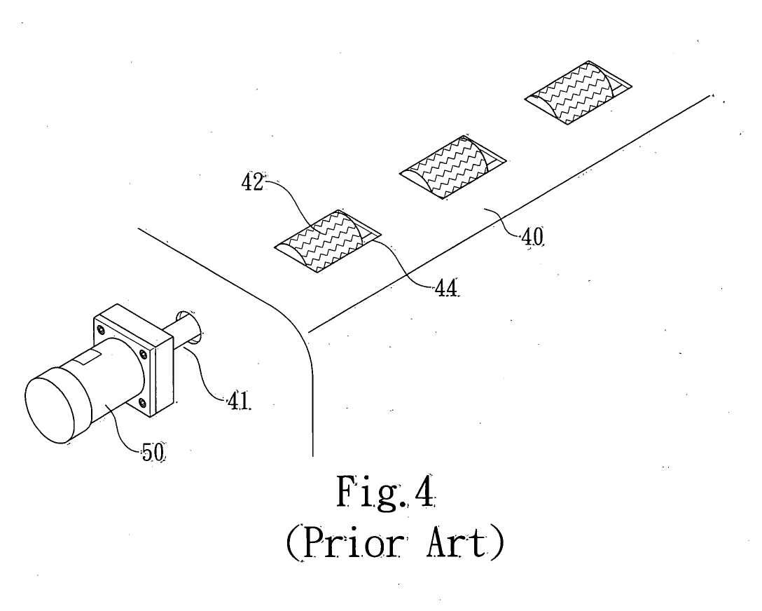

### DETAILED DESCRIPTION OF THE PREFERRED EMBODIMENTS

The present invention discloses a drum-changeable device for a printer comprising a plurality of drums 10,12 and a switch device 20. The plural drums 10,12 are disposed under the work surface 30 of a printer. Each drum 10,12 has a plurality of protrusions 104, 124 covered by the same kind of material and the protrusions 104, 124 of different drum 10,12 are covered by different kind of material for moving forward printing articles of different kinds of material. The switch device 20 connected with the drums 10,12 are used for moving a suitable drum 10,12 toward the work surface 30 of the printer according to the different kinds of material of the printing articles.

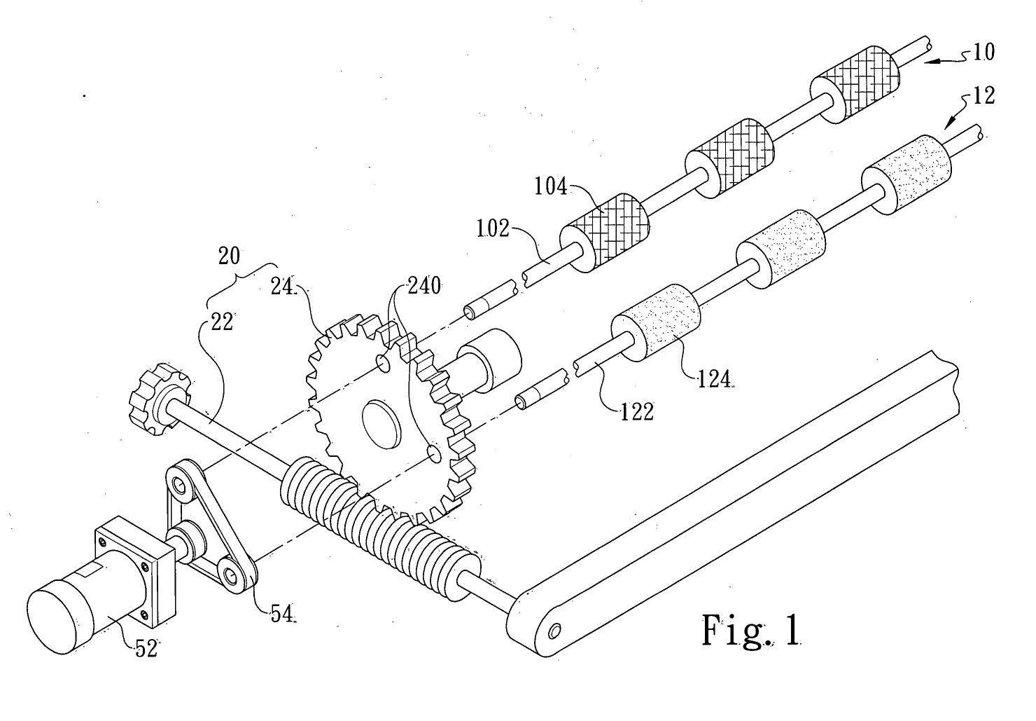

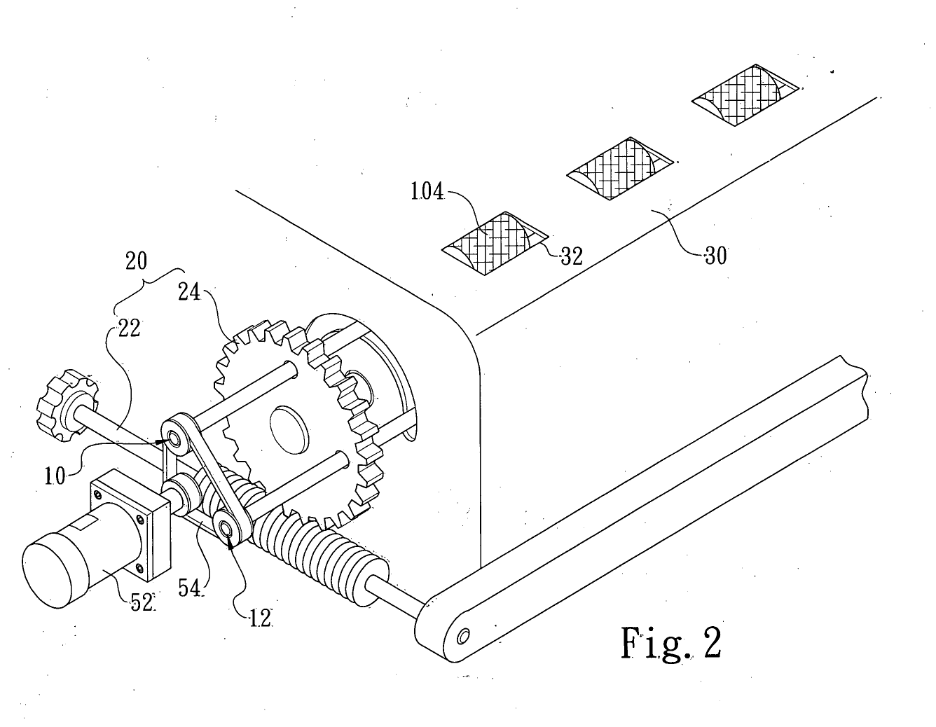

FIGS. 1 and 2 respectively show an exploded perspective view and a perspective view of a first embodiment of a drum-changeable device for a printer according to the present invention.

As shown in FIGS. 1 and 2, the drum-changeable device for a printer comprises two drums 10,12 and a switch device 20. One end of each drum 10,12 is connected with a motor 52 respectively via a belt 54.

In the first embodiment of the present invention, the drums 10,12 are disposed under the work surface 30 of the printer. Each drum 10,12 has an axial rod 102, 122 and a plurality of protrusions 104, 124. The protrusions 124 of one drum 12 are covered by soft material that is suitable for moving the printing articles of hard material while the protrusions 104 of the other drum 10 are covered by hard material that is suitable for moving the printing articles of soft material. The soft material used for covering the protrusions 124 of the drum 12 can be rubber or other similar kinds of material. The hard material used for covering the protrusions 104 of the drum 10 can be metal repousse or other similar kinds of material. Besides, openings 32 are provided on the work surface 30 and the protrusions 104, 124 protrude from the openings 32 on the work surface 30.

The switch device 20 includes a worm rod 22 and a worm gear 24. The worm gear 24 is connected with the worm rod 22 and drums 10, 12 respectively. In the first embodiment, the worm gear 24 has two holes 240 located near its center point for inserting axial rods 102, 122 of the drums 10, 12 respectively. Therefore, the worm gear 24 will be rotated by means of turning the worm rod 22 clockwise or counterclockwise and a suitable drum 10, 12 can be moved toward the work surface 30 of the printer by the rotation of the worm gear 24. By this way, the protrusions of the suitable drum 10, 12 will protrude out of the work surface 30 via the openings 32 for moving forward printing articles.

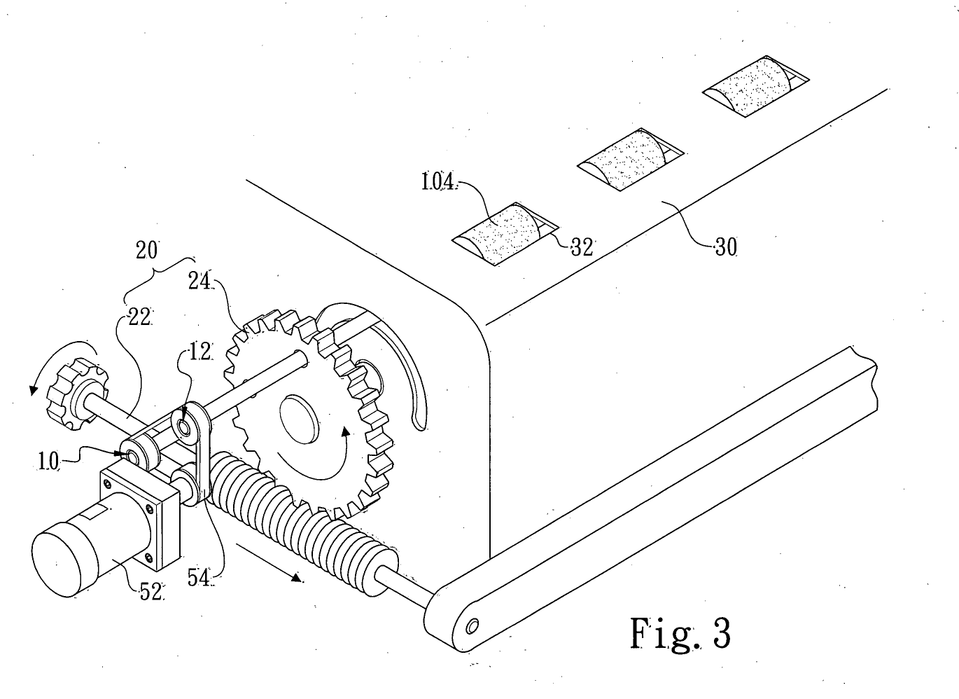

FIG. 3 shows a using state diagram of the drum-changeable device for a printer according to the present invention. When drums need to be changed according to different kinds of material of the printing articles, the switch device 20 can be used to select a suitable drum. As shown in FIG. 3, when the drum 12 needs to be changed, users can turn the worm rod 22 clockwise and the worm gear 24 will be rotated in the counterclockwise direction correspondingly as indicated by the arrow. Thus, the drum 12 can be moved toward the work surface 30 of the printer and the protrusions 124 of the drum 12 will protrude out of the openings 32 of the work surface 30 for moving forward the printing articles. If the drum 10 needs to be used later, the drum 10 can moved back toward the work surface 30 of the printer by turning the worm rod 22 in the counterclockwise direction.

Accordingly, as disclosed in the above description and attached drawings, the present invention can provide a drum-changeable device for a printer to select a suitable drum efficiently according to different kinds of material of printing articles. It is new and can be put into industrial use.

It should be understood that different modifications and variations could be made from the disclosures of the present invention by the people familiar in the art, which should be deemed without departing the spirit of the present invention.

What is claimed is:

1. A drum-changeable device for a printer, comprising:
a plurality of drums disposed under the work surface of a printer, where each drum has a plurality of protrusions covered by the same kind of material and the protrusions of different drum are covered by different kind of material for moving forward printing articles of different kinds of material; and
a switch device in connection with the drums for moving a suitable drum toward the work surface of the printer according to different kinds of material of the printing articles.

2. The drum-changeable device for a printer as claimed in claim 1, wherein the switch device further includes a worm rod and a worm gear that is connected to the worm rod and the worm gear is in connection with the drums.

3. The drum-changeable device for a printer as claimed in claim 1 including two drums, wherein one drum has protrusions covered by soft material that is suitable for moving printing articles of hard material while the other drum has protrusions covered by hard material that is suitable for moving printing articles of soft material.

4. The drum-changeable device for a printer as claimed in claim 3, wherein the soft material covering protrusions of one drum for moving the printing articles of hard material is rubber.

5. The drum-changeable device for a printer as claimed in claim 3, wherein the hard material covering protrusions of the other drum for moving the printing articles of soft material is metal repousse.
